(19) United States
(12) Patent Application Publication
(10) Pub. No.: US 2017/0123731 A1
(43) Pub. Date: May 4, 2017

(54) MANAGEMENT METHOD AND MANAGEMENT APPARATUS, AND STORAGE MEDIUM

(71) Applicant: HITACHI, LTD., Tokyo (JP)

(72) Inventors: Masafumi KASHIWAGI, Tokyo (JP); Yuusuke SHIRAKAMI, Tokyo (JP); Norihiro HARA, Tokyo (JP)

(73) Assignee: HITACHI, LTD., Tokyo (JP)

(21) Appl. No.: 15/318,990

(22) PCT Filed: Jan. 8, 2015
(86) PCT No.: PCT/JP2015/050412

§ 371 Date: Dec. 15, 2016

(51) Int. Cl. G06F 3/06; G06F 12/0806

(52) U.S. Cl. CPC G06F 3/0659; G06F 3/0604; G06F 3/067; G06F 12/0806; G06F 3/0613; G06F 2212/1008; G06F 2212/154; G06F 2212/608

(57) ABSTRACT

A management method and apparatus, and a storage medium, are capable of preventing the deterioration in the response performance of the overall system caused by the imbalance of the load between server apparatuses in a computer system equipped with a distributed shared file system. The management apparatus for managing a computer system is equipped with a distributed shared file system, and in cases where the load of a server containing a certain file is high upon updating that file, it selects another server with a low load as the temporary storage destination of the update data of that file, notifies the selected server as the write destination of the update data to the client, and, at the stage where the load of the server containing the file decreases, instructs the server retaining the update data to transfer the update data to the server containing the file.

### TECHNICAL FIELD

The present invention relates to a management method and a management apparatus, as well as to a storage medium, and is particularly suitable for application to computer systems equipped with a distributed shared file system function.

### BACKGROUND ART

In recent years, a distributed shared file system in which files are distributed and allocated in a plurality of I/O (Input/Output) servers or in storage devices connected to each of the plurality of I/O servers, and such files are made available as one file system, is in widespread use (refer to PTL 1). A distributed shared file system is unique in that a file created by a certain client can be used by another client.

### CITATION LIST

### Patent Literature

PTL 1: International Publication No. 2013/065151

### SUMMARY OF THE INVENTION

### Problems to be Solved by the Invention

In a computer system equipped with such a distributed shared file system, the I/O server as the allocation destination of a file is determined based on a round robin in file units. Thus, when creating files, the files are evenly distributed to the respective I/O servers, and no imbalance will arise in the load of the I/O servers.

Nevertheless, when a file is updated, there are cases where access is concentrated on the file retained in a specific I/O server, and in such a case the load of that I/O server will increase, and there is a problem in that the response performance of the overall system will deteriorate as a result of such I/O server becoming a bottleneck.

The present invention was devised in view of the foregoing points, and an object of this invention is to effectively prevent, in a computer system equipped with a distributed shared file system, the deterioration in the response performance of the overall system caused by the imbalance of the load between server apparatuses.

### Means to Solve the Problems

In order to achieve the foregoing object, the present invention provides a management method to be executed in a management apparatus for managing a computer system in which files created by one or more clients are distributed and allocated in a plurality of server apparatuses or in storage devices connected to each of the plurality of server apparatuses, and each of the files is made available to each of the clients as one file system, wherein the management apparatus includes: a load information collection unit which collects, from each of the server apparatuses, predetermined load information representing a load condition of the server apparatus; a load determination unit which determines the load condition of each of the server apparatuses based on each piece of the load information that was collected; and a write/read destination selection unit which, in response to an inquiry from the client, selects the server apparatus to be used by the client as a read or write destination of the file, and notifies the selected server apparatus to the client, and wherein the management method comprises: a first step of the write/read destination selection unit, in cases where a load of the server apparatus containing the file is high upon updating that file, selecting another server apparatus with a low load as a temporary storage destination of update data of that file, and notifying the selected server apparatus to the client; and a second step of the load determination unit periodically or randomly determining a load condition of each of the server apparatuses, and, in cases where the update data of the file allocated in one of the server apparatuses is temporarily stored in the other server apparatus and the load of the server apparatus containing the file is low, instructing the server apparatus that is temporarily storing the update data to transfer the update data to the server apparatus containing the file.

The present invention additionally provides a management apparatus for managing a computer system in which files created by one or more clients are distributed and allocated in a plurality of server apparatuses or in storage devices connected to each of the plurality of server apparatuses, and each of the files is made available to each of the clients as one file system, comprising: a load information collection unit which collects, from each of the server apparatuses, predetermined load information representing a load condition of the server apparatus; a load determination unit which determines the load condition of each of the server apparatuses based on each piece of the load information that was collected; and a write/read destination selection unit which, in response to an inquiry from the client, selects the server apparatus to be used by the client as a read or write destination of the file, and notifies the selected server apparatus to the client, wherein the write/read destination selection unit: in cases where a load of the server apparatus containing the file is high upon updating that file, selects another server apparatus with a low load as a temporary storage destination of update data of that file, and notifies the selected server apparatus to the client; and wherein the load determination unit: periodically or randomly determines a load condition of each of the server apparatuses, and, in cases where the update data of the file allocated in one of the server apparatuses is temporarily stored in the other server apparatus and the load of the server apparatus containing the file is low, instructs the server apparatus that is temporarily storing the update data to transfer update data to the server apparatus containing the file.

The present invention additionally provides a storage medium storing a program for causing a management apparatus for managing a computer system in which files created by one or more clients are distributed and allocated in a plurality of server apparatuses or in storage devices connected to each of the plurality of server apparatuses, and each of the files is made available to each of the clients as one file system, to execute processing comprising: a first step of collecting, from each of the server apparatuses, predetermined load information representing a load condition of the server apparatus; a second step of determining the load condition of each of the server apparatuses based on each piece of the load information that was collected; a third step of, in response to an inquiry from the client, selecting the server apparatus to be used by the client as a read or write destination of the file, and notifying the selected server apparatus to the client on the one hand, and, in cases where a load of the server apparatus containing the file is high upon updating that file, selecting another server apparatus with a low load as a temporary storage destination of update data of that file, and notifying the selected server apparatus to the client; and a fourth step of periodically or randomly determining a load condition of each of the server apparatuses, and, in cases where the update data of the file allocated in one of the server apparatuses is temporarily stored in the other server apparatus and the load of the server apparatus containing the file is low, instructing the server apparatus that is temporarily storing the update data to transfer the update data to the server apparatus containing the file.

According to the management method, the management apparatus and the storage medium of the present invention, when the load of a server apparatus is high, it is possible to prevent the additional increase of the load of that server apparatus associated with the file update.

### Advantageous Effects of the Invention

According to the present invention, in a computer system equipped with a distributed shared file system, it is possible to effectively prevent the deterioration in the response performance of the overall system caused by the imbalance of the load between server apparatuses.

### BRIEF DESCRIPTION OF DRAWINGS

FIG. 1 is a block diagram showing the overall configuration of the computer system according to this embodiment.

FIG. 2 is a block diagram showing the software configuration of the computer system according to this embodiment.

FIG. 3 is a conceptual diagram showing a configuration example of the load management table.

FIG. 4 is a conceptual diagram showing a configuration example of the file location management table.

FIG. 5 is a conceptual diagram showing a configuration example of the cache management table.

FIG. 6 is a flowchart showing the processing routine of the load information collection and load determination processing.

FIG. 7 is a flowchart showing the processing routine of the load condition determination processing.

FIG. 8 is a flowchart showing the processing routine of the data return/file migration processing.

FIG. 9 is a flowchart showing the processing routine of the I/O processing.

FIG. 10A is a flowchart showing the processing routine of the I/O server selection processing.

FIG. 10B is a flowchart showing the processing routine of the I/O server selection processing.

### DESCRIPTION OF EMBODIMENTS

An embodiment of the present invention is now explained in detail with reference to the appended drawings.

### (1) Configuration of Computer System According to this Embodiment

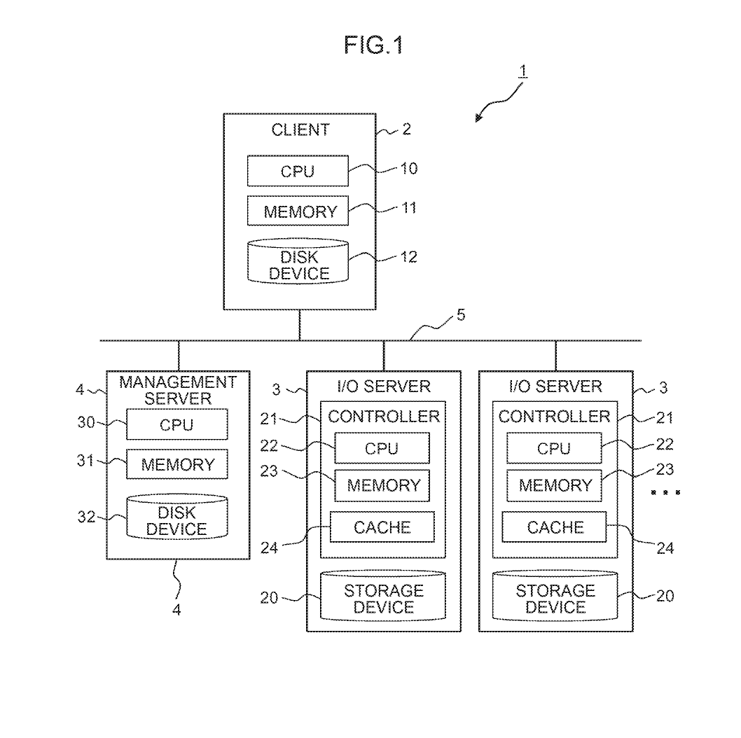

In FIG. 1, reference numeral 1 represents the computer system according to this embodiment. The computer system 1 is configured by one or more clients 2, a plurality of I/O servers 3 and a management server 4 being connected via a network 5.

The client 2 is a computer device that is used by a user for executing jobs, and is configured by comprising a CPU (Central Processing Unit) 10, a memory 11, a disk device 12 and other information processing resources.

The CPU 10 is a processor that governs the operational control of the overall client 2. The memory 11 is primarily used for storing various programs, and is also used as the work memory of the CPU 10. The disk device 12 is configured, for example, from a hard disk device, and is used for storing various programs and data for a long period.

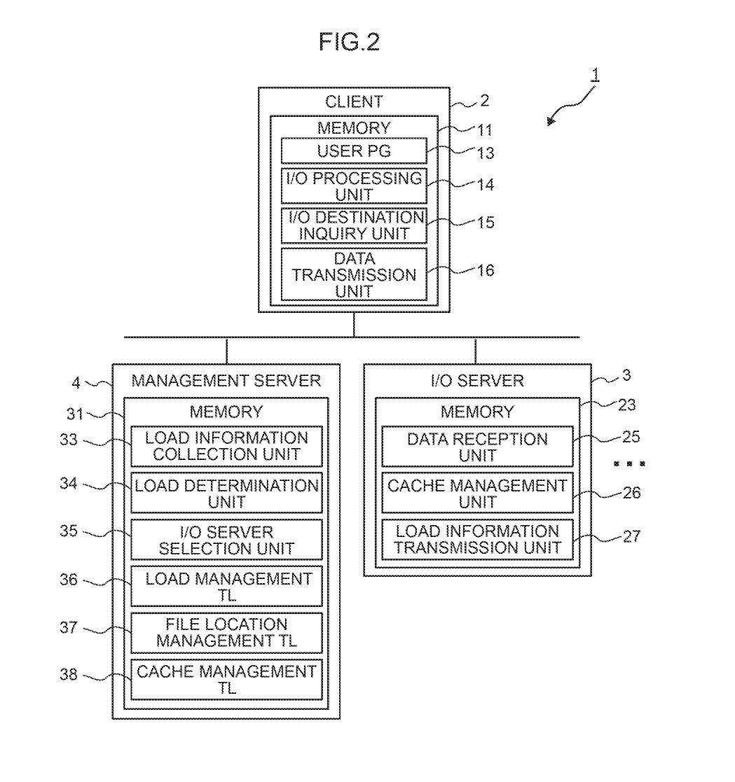

The memory 11 of the client 2 stores, as shown in FIG. 2, a user program 13, an I/O processing unit 14, an I/O inquiry unit 15 and a data transmission unit 16. The user program 13 is a program which executes various types of processing according to the jobs to be executed by the user who is using the client 2, and the I/O processing unit 14 is a program with a function of executing I/O processing in response to the I/O request from the user program 13. The I/O inquiry unit 15 is a program with a function of making an inquiry to the management server 4 regarding which I/O server 3 should be used as the file I/O destination in response to the request from the I/O processing unit 14. Furthermore, the data transmission unit 16 is a program with a function of issuing an I/O request to the I/O server 3 notified from the I/O inquiry unit 15.

The I/O server 3 is a server apparatus which provides, to the client 2, a storage area for reading and writing information, and is configured from a large-capacity non-volatile storage device 20, and a controller 21 which controls the input/output of data to and from the storage device 20.

The storage device 20 is configured, for example, from a plurality of hard disk devices such as magnetic disk devices, an SSD (Solid State Drive) such as a semiconductor memory device, or a RAID (Redundant Array of Inexpensive Disks).

Furthermore, the controller 21 is configured by comprising, for instance, a CPU 22, a memory 23 and a cache memory 24. The CPU 22 is a processor that governs the operational control of the overall I/O server 3. Moreover, the memory 23 is used for storing various programs, and also used as the work memory of the CPU 22. The cache memory 24 is a semiconductor memory that is used for temporarily storing the data to be input/output to and from the I/O server 3.

The memory 23 of the controller 21 stores, as shown in FIG. 2, a data reception unit 25, a cache management unit 26 and a load information transmission unit 27. The data reception unit 25 is a program with a function of receiving the file data of the file to be written, which is sent from the client 2, and temporarily storing the received file data in the cache memory 24. Moreover, the cache management unit 26 is a program with a function of managing the file data stored in the cache memory 24 and storing such file data in the storage device 20 at a proper timing. Furthermore, the load information transmission unit 27 is a program with a function of sending, to the management server 4, load information (described later) which represents the load condition of the host I/O server 3 in response to the request from the management server 4.

The management server 4 is a server apparatus that manages the I/O of the client to and from the I/O server 3, and is configured by comprising a CPU 30, a memory 31, a disk device 32 and other information processing resources. Since the CPU 30, the memory 31 and the disk device 32 have the same configuration and function as the corresponding units (CPU 10, memory 11 or disk device 12) of the client 2, the explanation thereof is omitted.

The memory 31 of the management server 4 stores, as shown in FIG. 2, a load information collection unit 33, a load determination unit 34 and an I/O server selection unit 35, as well as a load management table 36, a file location management table 37 and a cache management table 38. These units and tables will be described in detail later.

### (2) Distributed Shared File System Function According to this Embodiment

The distributed shared file system function applied to the computer system 1 is now explained. The computer system 1 is equipped with a distributed shared file system function capable of providing a distributed shared file system which enables the load distribution of the I/O server 3.

In effect, with the computer system 1 of this embodiment, when the client 2 is to create a new file (write a new file) in the I/O server 3 or read or write (update) a file from or to the I/O server 3, the client 2 makes an inquiry to the management server 4 regarding which I/O server 3 should be used for the creation, reading or writing (update) of that file.

The management server 4 manages the load condition of the respective I/O servers 3 and the allocation (placement) of the respective files. For example, when the management server 4 receives an inquiry from the client 2 regarding in which I/O server 3 the new file should be allocated, the management server 4 selects one I/O server 3 among the I/O servers 3 with a low load, and notifies the selected I/O server 3 as the I/O destination to the client 2.

Furthermore, when the management server 4 receives an inquiry from the client 2 regarding the I/O destination for reading a file, the management server 4 notifies the I/O server 3 containing that file as the I/O destination to the client 2. Consequently, the client 2 sends an I/O request to the I/O server 3 that was notified by the management server 4, and thereby stores the new file in that I/O server 3, or reads the file data of the intended file from that I/O server 3.

Furthermore, when the management server 4 receives an inquiry from the client 2 regarding the I/O destination for writing (updating) a file, the management server 4 determines the load condition of the I/O server containing the file to be written (updated) (this I/O server is hereinafter referred to as the “target I/O server”) 3.

When the management server 4 determines that the load of the target I/O server 3 is low, the management server 4 notifies the target I/O server 3 as the write destination (I/O destination) of the update data of that file to the client 2. Consequently, the client 2 sends an I/O request to the I/O server 3 that was notified by the management server 4, and thereby writes the update data in that I/O server 3.

Meanwhile, when the management server 4 determines that the load of the target I/O server 3 of that file is high, the management server 4 selects another I/O server 3 with a low load as the I/O destination for temporarily storing the update data (this action is hereinafter referred to as “caching”), and notifies the selected I/O server to the client 2. Consequently, here, the client 2 sends an I/O request, and the update data, to the I/O server 3 that was notified by the management server 4. Consequently, the update data is temporarily stored (cashed) in the cache memory 24 of that I/O server 3.

Here, the client 2 notifies the I/O server 3 that the update data has been temporarily stored in that I/O server 3 so that the I/O server 3 does not write the update data into the storage device 20 (FIG. 1). Moreover, when the writing of the update data in the I/O server 3 is complete, the client 2 notifies the management server 4 to such effect.

Meanwhile, in a state where the update data of a certain file is cached in an I/O server 3 other than the target I/O server 3 as described above, when another client 2 issues an I/O request of that file and the I/O request is the reading of that file, the management server 4 notifies the I/O server 3 as the actual storage destination of the file data (target I/O server 3 and/or the I/O server 3 that is caching the update data of that file) as the I/O destination to the client 2. Moreover, when the I/O request is the update of that file, the management server 4 notifies the I/O server 3 that is caching the update data as the I/O destination to the client 2. Consequently, the client that received the foregoing notice performs I/O operations such as the writing of the update data of that file or the reading of that file to or from the I/O server 3 that was notified by the management server 4.

Meanwhile, the management server 4 is constantly monitoring the load condition of the respective I/O servers 3, and in cases where the load of an I/O server 3, which was previously of a high load, decreases, and the update data of the file allocated to that I/O server 3 is being cached in another I/O server 3, the management server 4 instructs the other I/O server 3 to return the cached update data to the target I/O server 3. Consequently, the I/O server 3 that received the foregoing instruction transfers the update data of the file, which is being cached therein, to the target I/O server 3.

However, the management server 4 is also counting the number of times that the update data of each file has been cached in an I/O server 3 other than the target I/O server 3 (this is hereinafter referred to as the “transfer count”). In cases where the transfer count exceeds a predetermined threshold (this is hereinafter referred to as the “transfer count threshold”) and the ratio of the update data relative to the file size of that file exceeds a predetermined threshold (for instance, this may be 50[%], and is hereinafter referred to as the “cache size ratio threshold”), the management server 4 instructs the target I/O server 3 to migrate the file from the target I/O server 3 to the I/O server 3 that is caching the update data thereof at such time.

Consequently, the target I/O server 3 that received the foregoing instruction transfers the entire file data of that file to the I/O server 3 that is caching the update data of that file, and deletes all file data of that file from the storage device 20 (FIG. 1) and the cache memory 24 (FIG. 1).

As means for realizing the foregoing distributed shared file system function according to this embodiment, the memory 31 of the management server 4 stores, as described above with reference to FIG. 2, a load information collection unit 33, a load determination unit 34 and an I/O server selection unit 35, as well as a load management table 36, a file location management table 37 and a cache management table 38.

The load information collection unit 33 is a program with a function of collecting from each I/O server 3 predetermined information representing the load condition of that I/O server 3 existing in the computer system 1 (this is hereinafter referred to as the “load information”). In the case of this embodiment, the load information collection unit 33 periodically or randomly collects as the load information of the I/O server 3, from each I/O server 3, a ratio of the file data that has not yet been stored in the storage device 20 among all file data retained in the cache memory 24 (this is hereinafter referred to as the “cache dirty ratio”), a fragmentation ratio of the file data in the cache memory 24 (this is hereinafter referred to as the “cache fragmentation ratio”), the number of system calls of writing/reading per second (this is hereinafter simply referred to as the “system call count”), and an average data size of I/O (this is hereinafter referred to as the “average I/O size”). The reason why the file fragmentation ratio is included in the load information is because, even in cases where the system call count per second is small, the load during the update of a file will be high in an I/O server 3 having a high fragmentation ratio of the file in the cache memory 24.

The load determination unit 34 is a program with a function of determining the load condition of each I/O server 3 based on the load information collected by the load information collection unit 33 from the respective I/O servers 3. In effect, the load determination unit 34 determines that load of an I/O server 3 is high in cases where one among the foregoing cache dirty ratio, cache fragmentation ratio and system call count is equal to or greater than a first threshold which is predetermined for each of the cache dirty ratio, cache fragmentation ratio and system call count (these thresholds are hereinafter respectively referred to as the “cache dirty ratio threshold”, “cache fragmentation ratio threshold” and “first system call count threshold”), or in cases where the system call count is equal to or greater than a second threshold which is predetermined for the system call count (this is hereinafter referred to as the “second system call count threshold”) and the average I/O size is equal to or greater than a first threshold which is predetermined for the average I/O size (this is hereinafter referred to as the “average I/O size threshold”), and determines that the load of an I/O server 3 is low in other cases.

Furthermore, the load determination unit 34 also comprises a function of periodically confirming whether the update data of the file allocated to the I/O server 3 in a low load condition has been cached in another I/O server 3, and, if such a file exists, controlling the corresponding I/O server 3 to return the file to the original I/O server 3 or migrate the file to the I/O server 3 that is caching the update data thereof. The details of this function will be explained later.

The I/O server selection unit 35 is a program with a function of selecting the I/O server 3 to be used as the I/O destination based on the determination result of the load condition of each I/O server 3 determined by the load determination unit 34 in response to the I/O request from the client 2.

In effect, when a new file is to be created, the I/O server selection unit 35 selects one I/O server 3 as the I/O destination based on the round robin method among the I/O servers 3 in a low load condition. Moreover, when the target I/O server 3 is in a low load condition upon updating a file, the I/O server selection unit 35 selects the target I/O server as the I/O destination. Furthermore, when the target I/O server 3 is in a high load condition upon updating a file and a part or all of the file data of that file is being cached in an I/O server 3 other than the target I/O server 3, the I/O server selection unit 35 selects that I/O server 3 as the I/O destination. In addition, when the target I/O server 3 is in a high load condition upon updating a file and the file data of that file has not yet been cached in an I/O server 3 other than the target I/O server 3, the I/O server selection unit 35 selects one I/O server 3 as the I/O destination based on the round robin method among the I/O servers 3 in a low load condition.

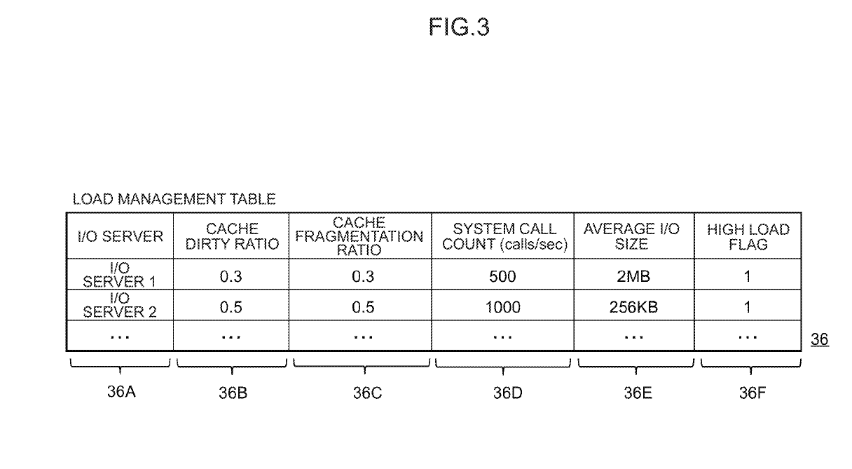

Meanwhile, the load management table 36 is a table that is used for managing the load information of the respective I/O servers 3 collected by the load information collection unit 33, and is configured by comprising, as shown in FIG. 3, an I/O server column 36A, a cache dirty ratio column 36B, a cache fragmentation ratio column 36C, a system call count column 36D, an average I/O size column 36E and a high load flag column 36F.

The I/O server column 36A stores the identifier (server ID) of each I/O server 3 existing in the computer system 1. Moreover, the cache dirty ratio column 36B, the cache fragmentation ratio column 36C, the system call count column 36D and the average I/O size column 36E respectively store corresponding information among the cache dirty ratio, the cache fragmentation ratio, the system call count and the average I/O size in the corresponding I/O server 3.

The high load flag column 36F stores the flag representing the load condition of the corresponding I/O server 3 which was determined by the load determination unit 34 (FIG. 2) based on the cache dirty ratio, the cache fragmentation ratio, the system call count and the average I/O size (this is hereinafter referred to as the “high load flag”). The high load flag is set to “1” when it is determined that the corresponding I/O server 3 is of a high load, and set to “0” when it is determined that the corresponding I/O server 3 is not of a high load.

Accordingly, in the case of the example of FIG. 3, the I/O server 3 identified as “I/O server 1” has a cache dirty ratio, cache fragmentation ratio, system call count and average I/O size of “0.3 (30%)”, “0.3 (30%)”, “500/sec” and “1 MB”, respectively, and has been determined to be of a high load (high load flag is “1”).

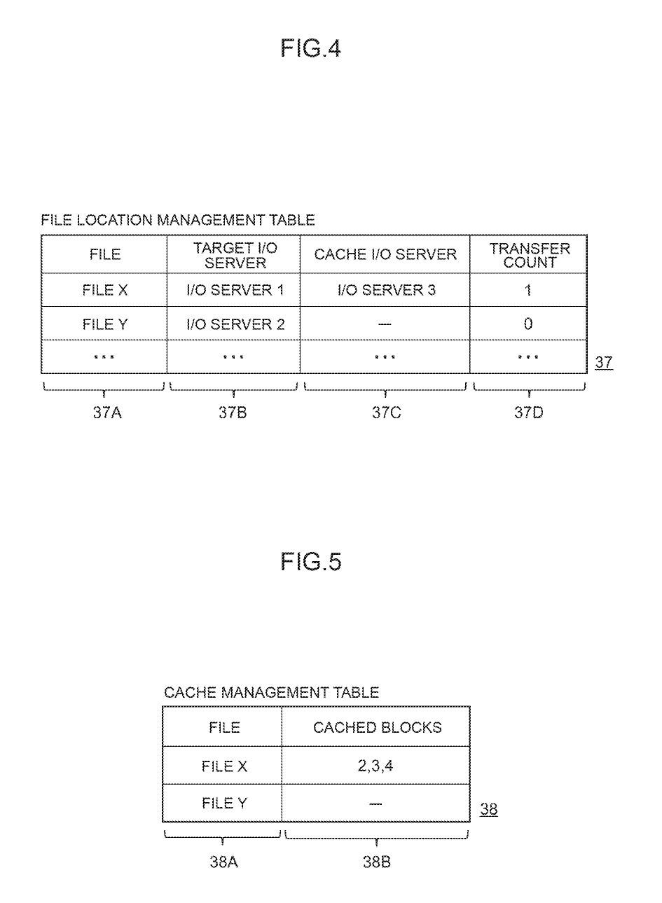

The file location management table 37 is a table that is used for managing in which I/O server 3 each of the files is allocated, and is configured by comprising, as shown in FIG. 4, a file column 37A, a target I/O server column 37B, a cache I/O server column 37C and a transfer count column 37D.

The file column 37A stores the file name of all files existing in the computer system 1, and the target I/O server column 37B stores the server ID of the target I/O server 3 of the corresponding file.

Moreover, in cases where the update data of the corresponding file is being cached in an I/O server 3 other than the target I/O server 3, the cache I/O server column 37C stores the server ID of the I/O server 3 that is caching the update data. Furthermore, the transfer count column 37D stores the number of times (transfer count) that the update data of the corresponding file has been cached in an I/O server 3 other than the target I/O server 3.

Accordingly, in the case of the example of FIG. 4, while the target I/O server 3 of the file identified as “file X” is “I/O server 1”, the update data thereof is being cached in the I/O server 3 identified as “I/O server 3”, and the transfer count thereof is “1”.

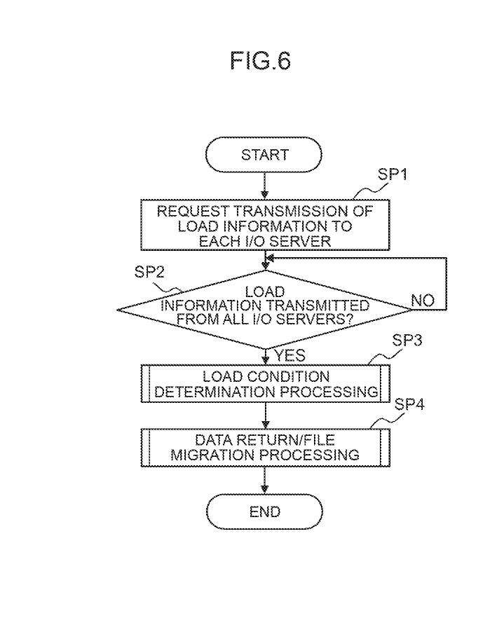

When the update data of a file is being cached in an I/O server 3 other than the target I/O server 3, the cache management table 38 is table that is used for managing which update data of which block of the file is being cached, and is configured by comprising, as shown in FIG. 5, a file column 38A and a cached block column 38B.

The file column 38A stores the file name of all files existing in the computer system 1 in the same manner as the file column 37A (FIG. 4) of the file location management table 37 (FIG. 4). Moreover, in cases where the update data of the corresponding file is being cached in another I/O server 3, the cached block column 38B stores all block numbers of the blocks corresponding to that update data in the file.

Accordingly, in the case of the example of FIG. 5, with regard to the file identified as “file X”, the update data of blocks “2, 3, 4” has been cached in one of the I/O servers 3, and with regard to the file identified as “file Y”, the update data thereof has not been cached in any one of the I/O servers 3.

### (3) Various Types of Processing Related to Distributed Shared File System Function

The various types of processing to be executed in the management server 4 or the client 2 in relation to the distributed shared file system function according to this embodiment are now explained. In the ensuing explanation, while the processing entity of the various types of processing is explained as a “program”, it goes without saying that, in effect, the CPU 30, 10 of the management server 4 or the client 2 executes the processing based on the program.

(3-1) Load Information Collection and Load Determination Processing

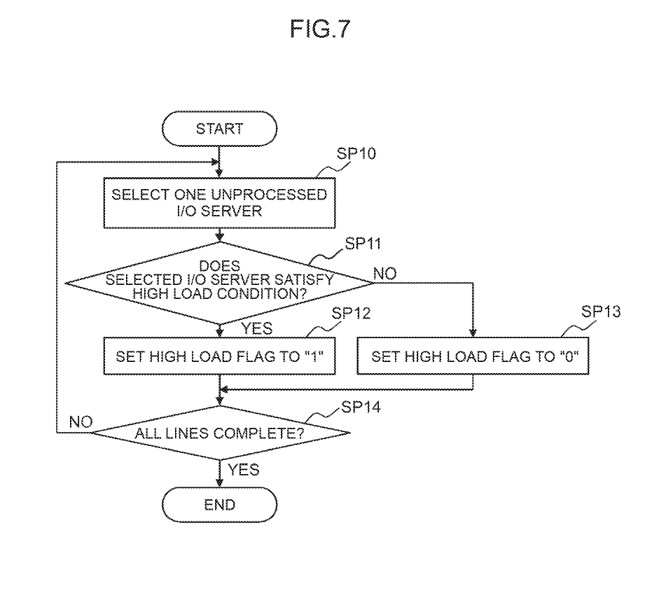

FIG. 6 shows the processing routine of the load information collection and load determination processing to be periodically executed in the management server 4. The management server 4 periodically starts the load information collection and load determination processing shown in FIG. 6, and the load information collection unit 33 (FIG. 2) foremost requests each I/O server 3 to send its load information (SP1).

Next, the load information collection unit 33 waits to receive the transmission of the load information from all I/O servers 3 existing in the computer system 1 (SP2), and, when the load information from all I/O servers 3 is eventually transmitted, calls the load determination unit 34 (FIG. 2).

When the load determination unit 34 is called by the load information collection unit 33, the load determination unit 34 determines the load condition of each I/O server 3, and executes the load condition determination processing for updating the load management table 36 (FIG. 3), as needed, based on the determination result (SP3). Specifically, when the load determination unit 34 determines that an I/O server 3 is of a high load condition, the load determination unit 34 sets the high load flag stored in the corresponding high load flag column 36F (FIG. 3) of the load management table 36 to “1”, and when the load determination unit 34 determines that an I/O server 3 is not of a high load condition, the load determination unit 34 sets the high load flag to “0”.

Next, in cases where there is a file in which the update data thereof is being cached in an I/O server 3 other than the target I/O server 3, the load determination unit 34 executes the data return/file migration processing for returning the update data of that file to the target I/O server 3 of that file, or migrating that file to the I/O server 3 that is caching the update data thereof (SP4).

The management server 4 thereafter ends the load information collection and load determination processing.

(3-2) Load Condition Determination Processing

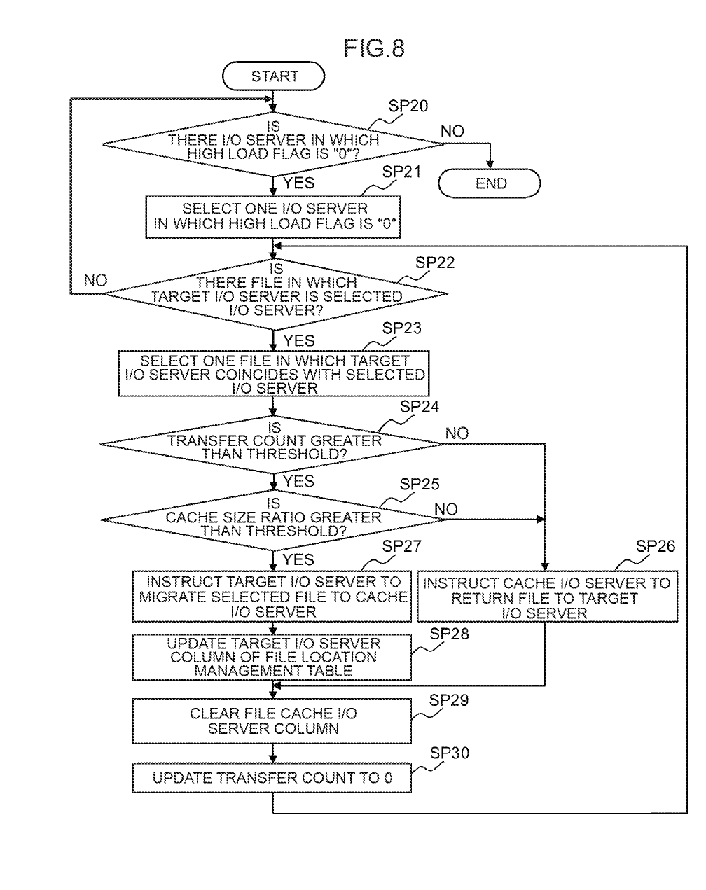

FIG. 7 shows the specific processing contents of the load condition determination processing to be executed by the load determination unit 34 of the management server 4 in step SP3 of the load information collection and load determination processing described above with reference to FIG. 6.

When the load determination unit 34 proceeds to step SP3 of the load information collection and load determination processing, the load determination unit 34 starts the load condition determination processing shown in FIG. 7, and foremost selects one unprocessed line among the respective lines of the load management table 36 (FIG. 3) (SP10).

Subsequently, the load determination unit 34 determines whether the cache dirty ratio, the cache fragmentation ratio, the system call count per second and the average I/O size of the I/O server 3 corresponding to the line selected in step SP10 (this is hereinafter referred to as the “selected line”) satisfy the conditions for determining that the I/O server 3 is of a high load (SP11).

Specifically, the load determination unit 34 determines, with regard to the I/O server 3 corresponding to the selected line, whether the cache dirty ratio is equal to or greater than the foregoing cache dirty ratio threshold, whether the cache fragmentation ratio is equal to or greater than the foregoing cache fragmentation ratio threshold, or whether the system call count is equal to or greater than the foregoing first system call count threshold, or whether the system call count is equal to or greater than the foregoing second system call count threshold and the average I/O size is equal to or greater than the foregoing average I/O size threshold.

When the load determination unit 34 obtains a positive result in the foregoing determination, the load determination unit 34 sets the high load flag stored in the high load flag column 36F of the selected line in the load management table 36 to “1” (SP12). Meanwhile, when the load determination unit 34 obtains a negative result in the determination of step SP11, the load determination unit 34 sets the high load flag to “0” (SP13).

Next, the load determination unit 34 determines whether the processing of step SP11 to step SP13 has been executed for all lines of the load management table 36 (SP14). When the load determination unit 34 obtains a negative result in the foregoing determination, the load determination unit 34 returns to step SP10, and thereafter repeats the processing of step SP10 to step SP14 while sequentially switching the line selected in step SP10 (selected line) to another unprocessed line.

When the load determination unit 34 eventually obtains a positive result in step SP14 as a result of the processing of step SP11 to step SP13 being executed for all lines of the load management table 36, the load determination unit 34 ends the load condition determination processing.

(3-3) Data Return/File Migration Processing

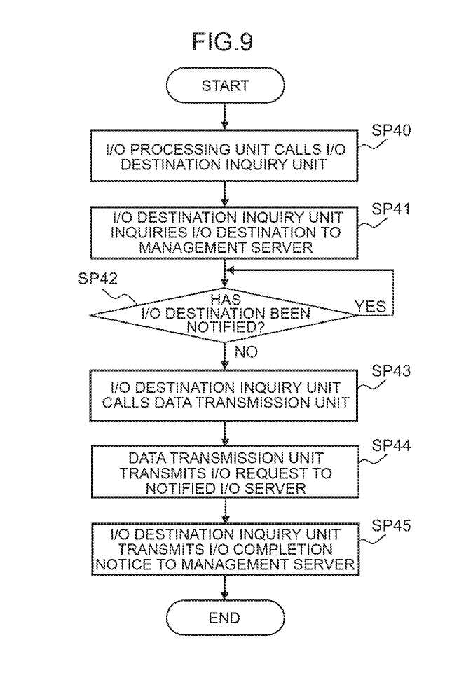

FIG. 8 shows the specific processing contents of the data return/file migration processing to be executed by the load determination unit 34 in step SP4 of the load information collection and load determination processing described above with reference to FIG. 6.

When the load determination unit 34 proceeds to step SP4 of the load information collection and load determination processing, the load determination unit 34 starts the data return/file migration processing shown in FIG. 8, and foremost determines whether there is an I/O server 3 in which the high load flag has been set to “0” among the I/O servers 3 registered in the load management table 36 (FIG. 3) (SP20). When the load determination unit 34 obtains a positive result in the foregoing determination, data return/file migration processing selects one I/O server 3 in which the high load flag has been set to “0” (SP21).

Subsequently, the load determination unit 34 determines whether there is a file, among the files registered in the file location management table 37 (FIG. 4), in which the server ID of the target I/O server 3 coincides with the server ID of the I/O server 3 selected in step SP21 (this is hereinafter referred to as the “selected I/O server 3”) (SP22).

To obtain a positive result in the foregoing determination means that the selected I/O server 3 is currently of a low load condition, but was previously of a high load condition, and the update data of the file allocated in the selected I/O server 3 has been cached in another I/O server 3, and the update data is still being cached in that other I/O server 3.

Consequently, here, the load determination unit 34 selects one file in which the target I/O server 3 coincides with the selected I/O server 3 (SP23), and determines whether the transfer count stored in the transfer count column 37D (FIG. 4) of the line corresponding to the file selected in step SP23 in the file location management table 37 (this is hereinafter referred to as the “selected file”) is greater than the foregoing transfer count threshold (SP24).

When the load determination unit 34 obtains a negative result in the foregoing determination, the load determination unit 34 instructs the I/O server 3 that is caching the update data of the selected file to return the update data to the target I/O server 3 (SP26).

Consequently, the I/O server 3 that received the foregoing instruction sends, to the target I/O server 3, the update data of the selected file that is being cached therein together with an I/O request (writing request). Consequently, the update data of the selected file that was being cached in an I/O server 3 other than the target I/O server 3 will be stored in the cache memory 24 (FIG. 1) of the target I/O server 3, and the selected file is thereby updated.

Meanwhile, when the load determination unit 34 obtains a positive result in the determination of step SP24, the load determination unit 34 determines whether the ratio of the data size of the update data relative to the file size of the overall selected file exceeds the foregoing cache size ratio threshold (SP25).

When the load determination unit 34 obtains a negative result in the foregoing determination, the load determination unit 34 proceeds to step SP26. Meanwhile, when the load determination unit 34 obtains a positive result in the foregoing determination, the load determination unit 34 instructs the target I/O server 3 of the selected file to migrate the selected file to the I/O server 3 that is caching the update data of the selected file (SP27).

Consequently, the target I/O server 3 of the selected file that received the foregoing instruction transfers the entire file data of the selected file, together with an I/O request (writing request), to the I/O server 3 that is caching the update data, and thereafter deletes all file data of the selected file that was being stored in the storage device 20 (FIG. 1).

Next, the load determination unit 34 overwrites the server ID stored in the target I/O server column 37B (FIG. 4) of the line corresponding to the selected file in the file location management table 37 with the server ID of the I/O server 3 in which the update data of the selected file had been previously cached (SP28).

Furthermore, the load determination unit 34 deletes (clears) the server ID stored in the cache I/O server column 37C (FIG. 4) of the line corresponding to the selected file in the file location management table 37 (SP29), and additionally updates the transfer count stored in the transfer count column 37D (FIG. 4) of that line to “0” (SP30).

Subsequently, the load determination unit 34 returns to step SP22, and thereafter repeats the process of step SP22 onward while sequentially switching the file selected in step SP23 (selected file) to another unprocessed corresponding file. Consequently, the processing of step SP23 to step SP30 will be executed for all files in which the target I/O server 3 is the selected I/O server 3.

When the load determination unit 34 eventually obtains a negative result in step SP22 as a result of the processing of step SP23 to step SP30 being executed for all files in which the target I/O server 3 is the selected I/O server 3, the load determination unit 34 returns to step SP20, and thereafter repeats the processing of step SP20 while sequentially switching the I/O server selected in step SP21 to another unprocessed I/O server. Consequently, the processing of step SP21 to step SP30 will be executed for all I/O servers 3 in which the high load flag has been set to “0”.

When the load determination unit 34 eventually obtains a negative result in step SP20 as a result of the processing of step SP20 to step SP30 being executed for all I/O servers 3 in which the high load flag has been set to “0”, the load determination unit 34 ends the data return/file migration processing.

(3-4) I/O Processing

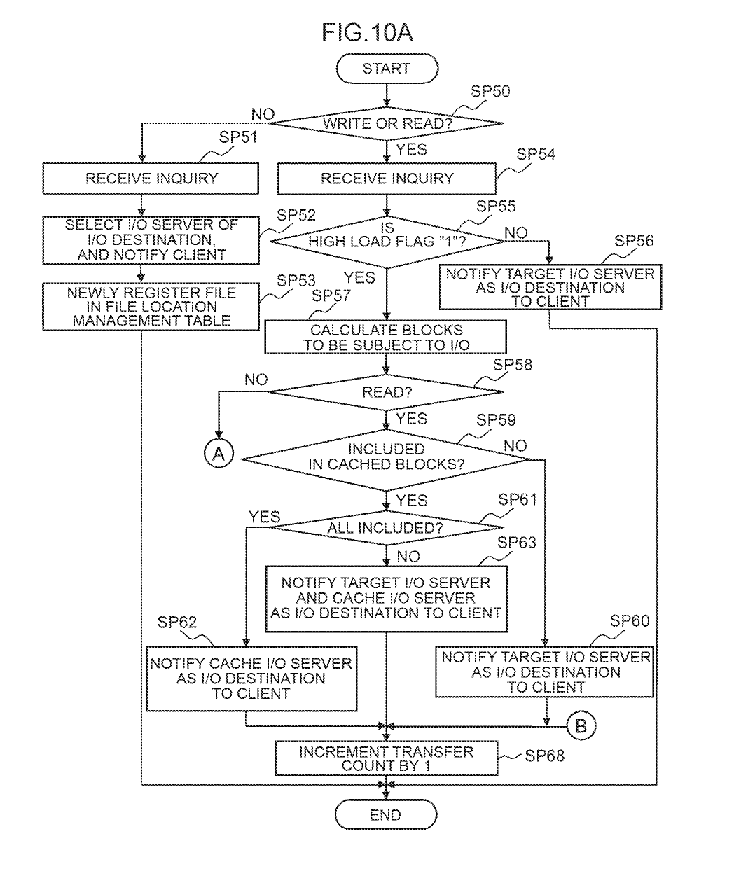

Meanwhile, FIG. 9 shows the processing routine of the I/O processing to be executed in the client 2. This I/O processing is started when the I/O processing unit 14 (FIG. 2) of the client 2 receives an I/O request from the user program 13 (FIG. 2), and, foremost, the I/O processing unit 14 that received the I/O request calls the I/O inquiry unit 15 (SP40).

When the I/O inquiry unit 15 is called by the I/O processing unit 14, the I/O inquiry unit 15 sends an I/O request to the I/O server selection unit 35 (FIG. 2) of the management server 4 to make an inquiry regarding which I/O server 3 should be used as the I/O destination (SP41), and thereafter waits to be notified of the I/O destination from the management server 4 (SP42).

When the I/O inquiry unit 15 is eventually notified of the I/O destination from the management server 4, the I/O inquiry unit 15 calls the data transmission unit 16 (FIG. 2) (SP43). Consequently, the data transmission unit 16 that was called by the I/O inquiry unit 15 sends an I/O request to the I/O server 3 of the I/O destination notified by the management server 4, and additionally sends the update data to that I/O server 3 when the I/O request is a write (update) request (SP44).

Subsequently, in cases where the I/O request was a write (update) request, the I/O inquiry unit 15 sends an I/O completion notice to the I/O server selection unit 35 of the management server 4 (SP45), and this I/O processing is thereafter ended. Consequently, the I/O server selection unit 35 that received the I/O completion notice updates, as needed, the information of the cached block column 38B (FIG. 5) of the line corresponding to the file written into the I/O server 3 at such time among the lines of the cache management table 38 (FIG. 5).

(3-5) I/O Server Selection Processing

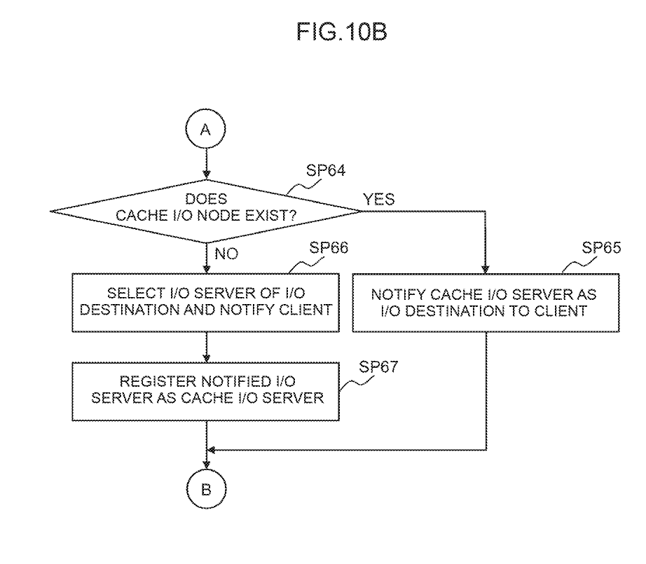

FIG. 10A and FIG. 10B show the processing routine of the I/O server selection processing to be executed by the I/O server selection unit 35 (FIG. 2) of the management server 4 that received the I/O request sent from the client 2 in step SP41 of the I/O processing described above with reference to FIG. 9.

When the management server 4 receives the I/O request from the client 2, the I/O server selection unit 35 starts the I/O server selection processing, and foremost determines whether the I/O to be executed by the client 2 is the read or write (update) of a file (SP50).

To obtain a negative result in the foregoing determination means that the I/O to be executed by the client 2 is the creation of a new file. Consequently, here, the I/O server selection unit 35 receives, from the client 2, the inquiry of the I/O destination and the file name of the file to be created, which is sent together with the inquiry (SP51).

Subsequently, the I/O server selection unit 35 selects one I/O server 3 among the I/O servers 3 in which the high load flag in the load management table 36 is set to “0” based on the round robin method, and notifies the selected I/O server 3 to the I/O inquiry unit 15 (FIG. 2) of the client 2 (SP52). Consequently, the client 2 that received the foregoing notice sends an I/O request to the I/O server 3 designated in the foregoing notice requesting the creation of a new file.

Next, the I/O server selection unit 35 newly registers the new file in the file location management table 37 (FIG. 4) (SP53). Specifically, the I/O server selection unit 35 secures a new line of the file location management table 37 and stores the file name of the file to be newly created, which was received in step SP41, in the file column 37A (FIG. 4) of that line, and stores, in the target I/O server column 37B (FIG. 4) of that line, the server ID of the I/O server 3 that was notified as the I/O destination to the client 2 in step SP42. The I/O server selection unit 35 thereafter ends the I/O server selection processing.

Meanwhile, when the I/O server selection unit 35 obtains a positive result in the determination of step SP50, the I/O server selection unit 35 receives the inquiry of the I/O destination from the client 2, the file name of the target file that is sent together with the inquiry (this is hereinafter referred to as the “target file”), the offset from the top-of-file of the location where the target file is to be read or written, and the size of the target file to be read or written (this is hereinafter referred to as the “I/O size”) (SP54).

Subsequently, the I/O server selection unit 35 reads the high load flag of the target I/O server 3 of the target file from the load management table 36 (FIG. 3), and determines whether the high load flag is set to “1” (SP55).

To obtain a negative result in the foregoing determination means that, currently, the target I/O server 3 of the target file is of a low load condition. Consequently, here, the I/O server selection unit 35 notifies the target I/O server 3 of the target file as the I/O destination of the target file to the client 2 (SP56), and thereafter ends the I/O server selection processing.

Meanwhile, to obtain a positive result in the determination of step SP55 means that, currently, the target I/O server 3 of the target file is of a high load condition. Consequently, here, the I/O server selection unit 35 calculates the blocks that are subject to I/O within the target file based on the offset and I/O size of the target file received in step SP54 (SP57).

Note that, the block number SBN of the start block of the blocks subject to I/O within the target file can be obtained as the calculation result of the following formula when the offset received in step SP44 is OFS and the block size is BLS (however, if the result is indivisible, the result shall be rounded off to the closest whole number). [Math 1]

Meanwhile, the block number of the end block of the blocks subject to I/O can be obtained as the value of the integer portion of the calculation result of the following formula when the I/O size of the target file received in step SP54 is IOS (similarly, if the result is indivisible, the result shall be rounded off to the closest whole number). [Math 2]

Next, the I/O server selection unit 35 determines whether the I/O to be executed by the client 2 is the reading of a file (SP58). When the I/O server selection unit 35 obtains a positive result in the foregoing determination, the I/O server selection unit 35 determines whether a part or all of the blocks subject to I/O, which were calculated based on the calculation in step SP57, are included a cached block stored in the cached block column 38B (FIG. 5) of the line corresponding to the target file of the cache management table 38 (FIG. 5) (SP59).

When the I/O server selection unit 35 obtains a negative result in the foregoing determination, the I/O server selection unit 35 notifies the target I/O server 3, in which the server ID is stored in the target I/O server column 37B of the line corresponding to the target file of the file location management table 37, as the I/O destination to the client 2 (SP60).

Consequently, when the I/O server selection unit 35 obtains a positive result in the determination of step SP59, the I/O server selection unit 35 determines whether all blocks subject to I/O, which were calculated based on the calculation in step SP57, are included in a cached block stored in the cached block column 38B of the line corresponding to the target file of the cache management table 38 (SP61).

When the I/O server selection unit 35 obtains a positive result in the foregoing determination, the I/O server selection unit 35 notifies the I/O server 3, in which the server ID is stored in the cache I/O server column 37C of the line corresponding to the target file of the file location management table 37, as the I/O destination to the client 2 (SP62).

Meanwhile, when the I/O server selection unit 35 obtains a negative result in the determination of step SP61, the I/O server selection unit 35 sets the target I/O server 3, in which the server ID is stored in the target I/O server column 37B of the line corresponding to the target file of the file location management table 37, as the I/O destination of the blocks in which data is retained in the target I/O server 3, and notifies the I/O server 3, in which the server ID is stored in the cache I/O server column 37C of the line corresponding to the target file of the file location management table 37, as the I/O destination of the blocks in which the update data is retained in the I/O server 3 to the client 2 (SP63).

Subsequently, when the processing of step SP60, step SP62 or step SP63 is completed, the I/O server selection unit 35 increments the value of the transfer count stored in the transfer count column 37D (FIG. 4) of the line corresponding to the target file of the file location management table 37 by “1” (SP68), and thereafter ends the I/O server selection processing.

Meanwhile, when the I/O server selection unit 35 obtains a negative result in the determination of step SP58, the I/O server selection unit 35 determines which I/O server 3 (server ID) is stored in the cache I/O server column 37C of the line corresponding to the target file of the file location management table 37 (SP64).

To obtain a positive result in the foregoing determination means that there is an I/O server 3 other than the target I/O server 3 that is caching the update data of the target file. Consequently, here, the I/O server selection unit 35 notifies the I/O server 3 in which the server ID is stored in the cache I/O server column 37C as the I/O destination to the client 2 (SP65).

Meanwhile, to obtain a negative result in the determination of step SP64 means that there is no I/O server 3 other than the target I/O server 3 that is caching the update data of the target file. Consequently, here, the I/O server selection unit 35 selects one I/O server 3 based on the round robin method among the I/O servers 3 in which the high load flag of the load management table 36 is set to “0”, and notifies the selected I/O server 3 as the I/O destination to the client 2 (SP66).

Furthermore, the I/O server selection unit 35 registers, in the file location management table 37, the I/O server 3 that was notified as the I/O destination to the client 2 in step SP66 as the I/O server 3 of the cache destination of the update data (SP67). Specifically, the I/O server selection unit 35 stores the server ID of the I/O server 3 that was notified as the I/O destination to the client 2 in step SP66 in the cache I/O server column 37C of the line corresponding to the target file of the file location management table 37.

When the I/O server selection unit 35 completes the processing of step SP65 or step SP67, the I/O server selection unit 35 increments the value of the transfer count stored in the transfer count column 37D of the line corresponding to the target file of the file location management table 37 by “1” (SP68), and thereafter ends the I/O server selection processing.

### (4) Effect of this Embodiment

As described above, with the computer system 1 of this embodiment, the load condition of the target I/O server 3 of the file is determined upon updating that file, and, when the target I/O server 3 is of a high load condition, the update data thereof is cached in another I/O server 3 of a low load condition.

Thus, according to the computer system 1, when the load of the I/O server 3 is high, it is possible to prevent the additional increase of the load of that I/O server 3 associated with the file update. Consequently, in the computer system 1 equipped with the distributed shared file system, it is possible to prevent the deterioration in the response performance of the overall system caused by the imbalance of the load between I/O servers 3.

Furthermore, with the computer system 1, since the update data is subsequently transferred to the target I/O server 3 or the remaining file data of that file is subsequently migrated to the I/O server 3 that is caching the update data at the stage that the load of the target I/O server 3 decreases, it is possible to prevent the file data from being distributed and continuously retained in different I/O servers 3. Thus, according to the computer system 1, it is possible to prevent the fragmentation of a file where the file data is distributed and retained in a plurality of I/O servers 3, and prevent the deterioration in the response performance during the parallel I/O of the file.

Furthermore, with the computer system 1, since the update data is migrated from the target I/O server 3 to the I/O server 3 that is caching the update data at such time when the transfer count is greater than the transfer count threshold and the data size of the update data is exceeding the cache size ratio threshold in the data return/file migration processing described above with reference to FIG. 8, it is possible to distribute the load of the target I/O server 3, which tends to become a high load, to another I/O server 3, and possible to further prevent the deterioration in the response performance of the overall system caused by the imbalance of the load between I/O servers 3.

### (5) Other Embodiments

While the foregoing embodiment explained a case where the storage device for storing the file from the client 2 is provided inside each I/O server 3, the present invention is not limited to the foregoing configuration, and the storage device 20 may also be provided outside the I/O server, and the storage device may be connected to each I/O server.

Furthermore, while the foregoing embodiment explained a case where the I/O server 3 is determined to be a high load in cases where one among the cache dirty ratio, the cache fragmentation ratio and the system call count is equal to or greater than the corresponding cache dirty ratio threshold, cache fragmentation ratio threshold or first system call count threshold, or in cases where the system call count is equal to or greater than the second system call count threshold and the average I/O size is equal to or greater than the average I/O size threshold, the present invention is not limited to the foregoing configuration, and the load of the I/O server 3 may also be determined based on other information.

Furthermore, while the foregoing embodiment explained a case where the load determination unit 34 of the management server 4 instructs the I/O server 2 of the allocation destination of the selected file to migrate the selected file to the I/O server 3 retaining the update data thereof only when a positive result is obtained in both step SP24 and step SP25 of FIG. 8, the present invention is not limited to the foregoing configuration, and the load determination unit 34 of the management server 4 may also instruct the I/O server 2 of the allocation destination of the selected file to migrate the selected file to the I/O server 3 retaining the update data thereof only when a positive result is obtained in at least either step SP24 or step SP25.

### INDUSTRIAL APPLICABILITY

The present invention can be broadly applied to computer systems of various configurations equipped with the distributed shared file system function.

### REFERENCE SIGNS LIST

1: Computer system
2: Client
3: I/O server
4: Management server
10, 22, 30: CPU
11, 23, 31: Memory
14: I/O processing unit
15: I/O inquiry unit
20: Storage device
21: Controller
24: Cache memory
25: Data reception unit
26: Cache management unit
27: Load information transmission unit
33: Load information collection unit
34: Load determination unit
35: I/O server selection unit
36: Load management table
37: File location management table
38: Cache management table

1. A management method to be executed in a management apparatus for managing a computer system in which files created by one or more clients are distributed and allocated in a plurality of server apparatuses or in storage devices connected to each of the plurality of server apparatuses, and each of the files is made available to each of the clients as one file system,
wherein the management apparatus includes:
a load information collection unit which collects, from each of the server apparatuses, predetermined load information representing a load condition of the server apparatus;
a load determination unit which determines the load condition of each of the server apparatuses based on each piece of the load information that was collected; and
a write/read destination selection unit which, in response to an inquiry from the client, selects the server apparatus to be used by the client as a read or write destination of the file, and notifies the selected server apparatus to the client, and
wherein the management method comprises:
a first step of the write/read destination selection unit, in cases where a load of the server apparatus containing the file is high upon updating that file, selecting another server apparatus with a low load as a temporary storage destination of update data of that file, and notifying the selected server apparatus to the client; and
a second step of the load determination unit periodically or randomly determining a load condition of each of the server apparatuses, and, in cases where the update data of the file allocated in one of the server apparatuses is temporarily stored in the other server apparatus and the load of the server apparatus containing the file is low, instructing the server apparatus that is temporarily storing the update data to transfer the update data to the server apparatus containing the file.

2. The management method according to claim 1,
wherein each of the server apparatuses comprises:
a cache memory which temporarily stores file data of the file to be read from or written into the corresponding storage device, and
wherein the load determination unit:
collects as the load information, from each of the server apparatuses, a cache dirty ratio which is a ratio of the file data that is not stored in the storage device among all of the file data stored in the cache memory, a cache fragmentation ratio which is a fragmentation ratio of the file data in the cache memory, a system call count of writing/reading per second, and an average I/O size which is an average data size of I/O.

3. The management method according to claim 2,
wherein the load determination unit:
determines that the load of the server apparatus is high in cases where one among the cache dirty ratio, the cache fragmentation ratio and the system call count is equal to or greater than a first threshold which is predetermined for each of the cache dirty ratio, the cache fragmentation ratio and the system call count, or in cases where the system call count is equal to or greater than a second threshold which is predetermined for the system call count and the average I/O size is equal to or greater than a first threshold which is predetermined for the average I/O size, and determines that the load of the server apparatus is low in other cases.

4. The management method according to claim 1,
wherein, in the second step, the load determination unit:
even in cases where the update data of the file allocated in one of the server apparatuses is temporarily stored in the other server apparatus and the load of the server apparatus containing the file is low, when a number of times (count) that the file has been temporarily stored in the server apparatus other than the server apparatus containing the file is greater than a predetermined third threshold, instructs the server apparatus containing the file to transfer that file to the server apparatus that is temporarily storing the update data of the file.

5. The management method according to claim 1,
wherein, in the second step, the load determination unit:
even in cases where the update data of the file allocated in one of the server apparatuses is temporarily stored in the other server apparatus and the load of the server apparatus containing the file is low, when a ratio of a data size of the update data temporarily stored in the other server apparatus relative to a file size of all of the files exceeds a predetermined fourth threshold, instructs the server apparatus containing the file to transfer that file to the server apparatus that is temporarily storing the update data of the file.

6. A management apparatus for managing a computer system in which files created by one or more clients are distributed and allocated in a plurality of server apparatuses or in storage devices connected to each of the plurality of server apparatuses, and each of the files is made available to each of the clients as one file system, comprising:
a load information collection unit which collects, from each of the server apparatuses, predetermined load information representing a load condition of the server apparatus;
a load determination unit which determines the load condition of each of the server apparatuses based on each piece of the load information that was collected; and
a write/read destination selection unit which, in response to an inquiry from the client, selects the server apparatus to be used by the client as a read or write destination of the file, and notifies the selected server apparatus to the client,
wherein the write/read destination selection unit:
in cases where a load of the server apparatus containing the file is high upon updating that file, selects another server apparatus with a low load as a temporary storage destination of update data of that file, and notifies the selected server apparatus to the client; and
wherein the load determination unit:
periodically or randomly determines a load condition of each of the server apparatuses, and, in cases where the update data of the file allocated in one of the server apparatuses is temporarily stored in the other server apparatus and the load of the server apparatus containing the file is low, instructs the server apparatus that is temporarily storing the update data to transfer update data to the server apparatus containing the file.

7. The management apparatus according to claim 6,
wherein each of the server apparatuses comprises:
a cache memory which temporarily stores file data of the file to be read from or written into the corresponding storage device, and
wherein the load determination unit:
collects as the load information, from each of the server apparatuses, a cache dirty ratio which is a ratio of the file data that is not stored in the storage device among all of the file data stored in the cache memory, a cache fragmentation ratio which is a fragmentation ratio of the file data in the cache memory, a system call count of writing/reading per second, and an average I/O size which is an average data size of I/O.

8. The management apparatus according to claim 7,
wherein the load determination unit:
determines that the load of the server apparatus is high in cases where one among the cache dirty ratio, the cache fragmentation ratio and the system call count is equal to or greater than a first threshold which is predetermined for each of the cache dirty ratio, the cache fragmentation ratio and the system call count, or in cases where the system call count is equal to or greater than a second threshold which is predetermined for the system call count and the average I/O size is equal to or greater than a first threshold which is predetermined for the average I/O size, and determines that the load of the server apparatus is low in other cases.

9. The management apparatus according to claim 6,
wherein the load determination unit:
even in cases where the update data of the file allocated in one of the server apparatuses is temporarily stored in the other server apparatus and the load of the server apparatus containing the file is low, when a number of times (count) that the file has been temporarily stored in the server apparatus other than the server apparatus containing the file is greater than a predetermined third threshold, instructs the server apparatus containing the file to transfer that file to the server apparatus that is temporarily storing the update data of the file.

10. The management apparatus according to claim 6,
wherein the load determination unit:
even in cases where the update data of the file allocated in one of the server apparatuses is temporarily stored in the other server apparatus and the load of the server apparatus containing the file is low, when a ratio of a data size of the update data temporarily stored in the other server apparatus relative to a file size of all of the files exceeds a predetermined fourth threshold, instructs the server apparatus containing the file to transfer that file to the server apparatus that is temporarily storing the update data of the file.

11. A storage medium storing a program for causing a management apparatus for managing a computer system in which files created by one or more clients are distributed and allocated in a plurality of server apparatuses or in storage devices connected to each of the plurality of server apparatuses, and each of the files is made available to each of the clients as one file system, to execute processing comprising:
a first step of collecting, from each of the server apparatuses, predetermined load information representing a load condition of the server apparatus;
a second step of determining the load condition of each of the server apparatuses based on each piece of the load information that was collected;
a third step of, in response to an inquiry from the client, selecting the server apparatus to be used by the client as a read or write destination of the file, and notifying the selected server apparatus to the client on the one hand, and, in cases where a load of the server apparatus containing the file is high upon updating that file, selecting another server apparatus with a low load as a temporary storage destination of update data of that file, and notifying the selected server apparatus to the client; and
a fourth step of periodically or randomly determining a load condition of each of the server apparatuses, and, in cases where the update data of the file allocated in one of the server apparatuses is temporarily stored in the other server apparatus and the load of the server apparatus containing the file is low, instructing the server apparatus that is temporarily storing the update data to transfer the update data to the server apparatus containing the file.
